(19) United States
(12) Patent Application Publication
(10) Pub. No.: US 2025/0053977 A1
(43) Pub. Date: Feb. 13, 2025

(54) DECENTRALIZED IDENTITY-BASED ACCOUNT AND USER VERIFICATION

(71) Applicant: American Express Travel Related Services Company, Inc., New York, NY (US)

(72) Inventors: Andras L. Ferenczi, Peoria, AZ (US); Alaric M. Eby, Scottsdale, AZ (US); Matthew Stephen Bodell, New York, NY (US); Jaime A. Cruz-Herrera, Jersey City, NJ (US)

(21) Appl. No.: 18/933,753

(22) Filed: Oct. 31, 2024

Related U.S. Application Data
(62) Division of application No. 17/565,630, filed on Dec. 30, 2021.

(51) Int. Cl. G06Q 20/40; G06Q 20/38

(52) U.S. Cl. CPC G06Q 20/401; G06Q 20/3829

(57) ABSTRACT

Disclosed are various embodiments for using decentralized identity to verify account information for a user requesting a transfer of funds between one or more financial entities (e.g., banks, credit unions, brokerage firms, mortgage companies, etc.). A user having account with a first entity can request that a balance credential be created claiming that the balance of funds within the account meets or exceeds a predefined threshold. The balance credential can be created and saved on a distributed ledger in relation to a decentralized identity identifier (DID) of the user. When a second entity wants to verify the account balance of the user, the verifying entity which can use the DID to access the balance credential on the distributed ledger and validate the accessed credential.

### CROSS REFERENCE TO RELATED APPLICATIONS

This application is a divisional of, and claims priority to and the benefit of, U.S. patent application Ser. No. 17/565,630, filed on Dec. 30, 2021, which is incorporated herein by reference in its entirety.

### BACKGROUND

When a user initiates a funds payment process (e.g., automated clearing house (ACH) request, wire transfer, loan request, etc.) through a financial entity, the financial entity may want to inquire about the requesting user to verify account balances of user accounts associated with the user as well as other types of user information (e.g., name, address, etc.). For example, for an ACH payment, a first financial entity (e.g., Bank A) receiving the funds from a second financial entity (e.g., Bank B) may want to verify that the user account provided by the other financial entity has the amount of funds being requested for the transfer prior to initiating the transfer of funds from Bank B to Bank A. Similarly, for a loan request, a first financial entity providing the funds for the loan may want to verify that the user has a certain account balance in a user account associated with the user and a second financial entity prior to advancing a loan to the user.

Traditionally, for account and user verification, a financial entity that is requested by a user to execute a funds payment process request may engage the services of a third-party entity (e.g., Yoodle®, Plaid®, etc.) to verify account information of the user. However, the use of a third-party entity can result in both security and privacy concerns. For example, the user may be required to provide credentials to the third-party entity to allow the third-party entity access to the user's account information with another financial entity. In addition, the user must trust that the third-party entity will not sell or steal his or her personal information. Likewise, the financial entity must trust the third-party's ability to accurately verify the user account information.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIGS. 2-4 are sequence diagrams illustrating examples of functionality in the network environment of FIG. 1 according to various embodiments of the present disclosure.

### DETAILED DESCRIPTION

Disclosed are various approaches for using decentralized identity services to verify account information for a user requesting a transfer of funds between one or more financial entities (e.g., banks, credit unions, brokerage firms, mortgage companies, etc.). In various examples, a financial entity initiating a transfer of funds (e.g., an automated clearing house (ACH) payment, a loan advance, a wire transfer, etc.) may require that a user associated with the funds transfer request has a minimum balance in one or more financial accounts. Typically, to verify that the minimum balance is satisfied, the financial entity associated with the one or more financial accounts can be contacted using a third-party entity (e.g., Yoodle®, Plaid®, etc.) to obtain the financial account data associated with the one or more financial accounts. This requires additional time to process the funds transfer. In addition, this can lead to security and privacy concerns as credential data for accessing the financial account data may be required and the third-party entities accessing the financial account data must be trusted to not sell and/or improperly use the accessed data or the credential data. Further, in some situations, the obtained financial account data may disclose too much information. For example, the financial account data may indicate that a user has a much higher account balance that what is needed by the initiating financial entity to execute the funds request.

To solve these problems, the present disclosure provides approaches for minimum balance verification using decentralized identity services. According to various examples, a user having a financial account with a financial institution can request that the financial institution create a balance credential claiming that the balance of funds within the financial account meets or exceeds a predefined threshold. The financial institution can create the balance credential and store the business credential on a distributed ledger in relation to a decentralized identity identifier (DID) that is associated with the user. Accordingly, when another financial institution or other type of entity wants to verify the account balance of the user, a wallet on a user device of the user, can provide the DID to the verifying entity which can then use the DID to access the balance credential on the distributed ledger. The verifying entity can than verify the stored credential and execute the exchange of funds as requested without the additional steps as well as the security and privacy concerns that are all associated with traditional verification approaches.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

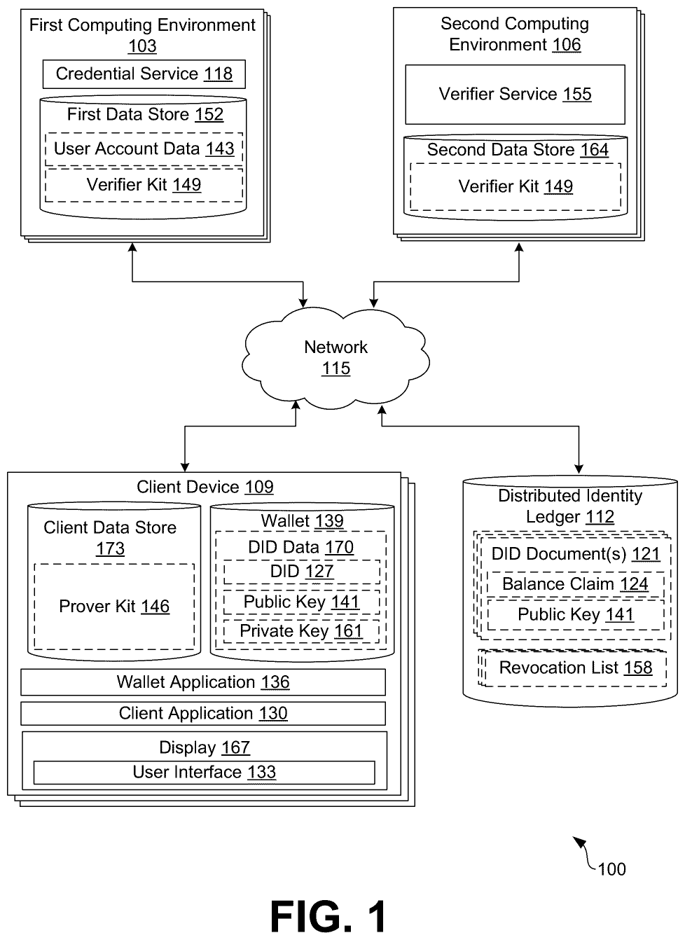

With reference to FIG. 1, shown is a network environment 100 according to various embodiments. The network environment 100 can include a first computing environment 103, a second computing environment 106, a client device 109, and a distributed identity ledger 112, which can be in data communication with each other via a network 115.

The network 115 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 115 can also include a combination of two or more networks 115. Examples of networks 115 can include the Internet, intranets, extranets, virtual private networks (VPNs), and similar networks.

In various examples, the first computing environment 103 corresponds to a system that can generate credentials claiming various features associated with a user associated with the client device 109. For example, the first computing environment 103 can correspond to a financial institution (e.g., bank, credit union, brokerage firm, mortgage company, etc.) associated with one or more financial accounts of the user. In this example, the first computing environment 103 can manage the financial accounts associated with the user and can attest to the account balance associated with the one or more financial accounts associated with the user.

The first computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the first computing environment 103 can employ a plurality of computing devices that can be arranged in one or more server banks or computer banks or other arrangements. Such computing devices can be located in a single installation or can be distributed among many different geographical locations. For example, the first computing environment 103 can include a plurality of computing devices that together can include a hosted computing resource, a grid computing resource or any other distributed computing arrangement. In some cases, the first computing environment 103 can correspond to an elastic computing resource where the allotted capacity of processing, network, storage, or other computing-related resources can vary over time.

Various applications or other functionality can be executed in the first computing environment 103. The components executed on the first computing environment 103 include a credential service 118, and other applications, services, processes, systems, engines, or functionality not discussed in detail herein.

The credential service 118 can be executed to create a decentralized identifier (DID) document 121 that can include a balance claim 124 claiming that the account balance for a user account associated with a DID 127 of the user satisfies a minimum balance threshold. In particular, a DID document 121 comprises a document that can be written to and accessed from a distributed identity ledger 112. The DID document 121 is generated to include information related to a user identified by a specific DID 127. In various examples, the credential service 118 can further write the DID document 121 to the distributed identity ledger 112 according to the DID 127. In various examples, the DID document 121 is implemented using various standards, such as the World Wide Web Consortium's (W3C's) Decentralized Identifier (DID) standard.

According to various examples, the credential service 118 can create the DID document 121 and corresponding balance claim 124 in response to a request from a client application 130 executing on the client device 109. In various examples, the credential service 118 can invite a user interacting with a user interface 133 associated with the first computing environment 103 to register with a balance credential program provided by the credential service 118 that allows the credential service 118 to generate the balance claim 124 according to an account balance for one or more financial accounts of the user that are provided by a financial entity of the first computing environment 103. In various examples, the credential service 118 can detect a wallet application 136 and/or corresponding wallet 139 associated with the client device 109 in response to interactions with the client device 109 and, in response, can submit the invitation for the user to participate in the balance credential program.

Upon accepting the request, the credential service 118 can initiate a decentralized identity session with the client device 106 which leads to the credential service 118 receiving the DID 127 and an associated public key 141 from the wallet application 136 executing on the client device 109. The credential service 118 creates the balance claim 124 according to a minimum balance threshold. In some examples, the minimum balance threshold is defined by an agreement between the user and the entity associated with the first computing environment 103. In other examples, the minimum balance threshold is defined by the entity associated with the first computing environment 103.

In various examples, the credential service 118 can analyze the user account data 143 associated with the user or user financial account interacting with the credential service 118 and determine if the account balance of the financial account meets or exceeds the minimum balance threshold. If the account balance meets or exceeds the minimum balance threshold, the credential service 118 can generate the balance claim 124 and corresponding DID document 121. The balance claim 127 could also be implemented using various standards, such as the World Wide Web Consortium's (W3C's) Decentralized Identifier (DID) standard.

In some examples, the credential service 118 can monitor the account balances associated with the registered balanced claims 124 to ensure that the account balances continue to meet or exceed the predefined minimum balance threshold. In the event that a given account balance drops below the minimum balance threshold, the credential service 118 can revoke corresponding credential (e.g., DID document and balance claim 124) such that a verifying party will be able to determine that the minimum balance threshold is not met for a given DID 127. For example, the revocation list 158 stored in the distributed identity ledger 112 can be updated to indicate that the corresponding credential has been revoked. The revocation of the credential can be implemented according to various standards, such as the World Wide Web Consortium's (W3C's) Decentralized Identifier (DID) standard.

In various examples, the credential service 118 can be executed to generate a prover kit 146 and a verifier kit 149 that can be used by the client device 109 and the second computing environment 106 to verify user information associated with the user associated with a specific DID 127. For example, the prover kit 146 and the verifier kit 149 can be generated to verify a user name, a user address, a user account, an account balance, and/or other types of information.

In some examples, the prover kit 146 and the verifier kit 149 can be generated to verify that an account balance associated with the user is within a given threshold. For example, while the balance claim 124 associated with the DID 127 may indicate that the account balance meets or exceed a predefined minimum balance threshold, the second computing environment 106 may want to verify that the account balance meets or exceeds a balance that differs from the predefined minimum balance threshold. In this example, the prover kit 146 and the verifier kit 149 can be generated to verify that the account balance is within a range that differs from the minimum balance threshold. Once generated, the credential service 118 can transmit the prover kit 146 to the corresponding client device 109 and transmit the verifier kit 149 to the second computing environment 106. In some examples, the verifier kit 149 is published for public access by the credential service 118 and can be provided to the second computing environment 106 upon request.

According to various examples, the prover kit 146 and verifier kit 149 can be generated based at least in part on a zero-knowledge proof algorithm. For example, the prover kit 146 can be generated to generate a zero-knowledge proof that can be used by the verifier kit 149 to verify the user account information. A zero-knowledge proof is a method by which a proving party (e.g., the client device 109) can prove to a verifying party (e.g., the second computing environment 106) that they possess certain information (e.g., user identification) while only providing to the verifying party the fact that they possess the information (e.g., no transfer of biometric data). As such, the proving party is in possession of information that is not provided to the verifying party, and the verifying party is able to prove that the information is what the proving party asserts the information to be through a performance of the steps of the zero-knowledge proof. An interactive zero-knowledge proof requires interactions between the two-parties, so that the verifying party can validate the proof. In contrast, a non-interactive zero-knowledge proof is a method that allows the verifier to validate the proof without any type of interaction from the proving party.

Also, various data is stored in a first data store 152 that is accessible to the first computing environment 103. The first data store 152 can be representative of a plurality of first data stores 152, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the first data store 152 is associated with the operation of the various applications or functional entities described below. This data can include user account data 143, a verifier kit 149, and potentially other data.

The user account data 143 can correspond to a financial account associated with a user and provided and managed by the entity associated with the first computing environment 103. The user account data 143 an account holder name, an account holder address, an account number, an account balance, an account transaction ledger, and/or other data.

The verifier kit 149 can represent a script, application, or process that can be executed by the verifier service 155 in the second computing environment 106 to verify the proof that is a result of the prover kit 146 executed on the client device 109. The verifier kit 149 is generated by the credential service 118 and can be publicly stored in the first data store 152 for access by the verifier service 155 of the second computing environment 106. According to various embodiments, the verifier kit 149 can be configured to work in conjunction with the prover kit 146 executed on the client device 109. For example, the verifier service 155 can verify the user verification proof provided by a client device 109 (e.g., the result of the prover kit 146) in order to prove or otherwise validate the identity of the user initiating the funds transfer and/or the account balance of a financial account of the user initiating the funds transfer.

In various examples, the second computing environment 106 corresponds to a system that can verify credentials claiming various features associated with a user associated with the client device 109. For example, the second computing environment 106 can correspond to a financial institution (e.g., bank, credit unions, brokerage firms, mortgage companies, etc.) or other entity that can initiate a transfer of funds between one or more financial intuitions and verify the financial account data associated with a user requesting the transfer of funds. For example, the financial institution may initiate an ACH payment process, a loan advance process, a wire transfer and/or other type of funds transfer.

The second computing environment 106 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the second computing environment 106 can employ a plurality of computing devices that can be arranged in one or more server banks or computer banks or other arrangements. Such computing devices can be located in a single installation or can be distributed among many different geographical locations. For example, the second computing environment 106 can include a plurality of computing devices that together can include a hosted computing resource, a grid computing resource or any other distributed computing arrangement. In some cases, the second computing environment 106 can correspond to an elastic computing resource where the allotted capacity of processing, network, storage, or other computing-related resources can vary over time.

Various applications or other functionality can be executed in the second computing environment 106. The components executed on the second computing environment 106 include a verifier service 155, and other applications, services, processes, systems, engines, or functionality not discussed in detail herein.

The verifier service 155 can be executed to verify user information associated with a user requesting an exchange of funds between one or more entities. In various examples, the verifier service 155 can interact with a client device 109 associated with a user requesting an exchange of funds between one or more entities. Prior to initiating the exchange of funds, the verifier service 155 can verify the user information by verifying the balance claim 124 included in the DID document 121 that is associated with the DID 127 of the user and stored in the distributed identity ledger 112.

In various examples, the verifier service 155 can initiate an identity verification process with the client device 109 in order to receive the DID 127 associated with the requesting user from the client device 109. Upon receiving the DID 127 from the client device 109, the verifier service 155 can access the DID document 121 from the distributed identity ledger 112 using the DID 127 and validate the DID document 121 and corresponding balance claim 124. In various examples, the verifier service 115 can validate the DID document 121 by determining that the DID document 121 was created and signed by a trusted entity (e.g., the first computing environment 103 or credential service 118). In addition, the verifier service 155 can determine whether the balance claim 124 indicates that the account balance of the corresponding financial account meets or exceeds the minimum threshold amount. In addition, the verifier service 155 can determine whether balance claim 124 has been revoked or if it is still active. For example, if the balance claim 124 is revoked (e.g., the account balance no longer meets or exceeds the minimum balance threshold), reference to the balance claim 124 or DID 127 may be included in a revocation list 158 stored in the identified ledger 112.

In various examples, the verifier service 155 can be executed to verify that the requesting user is the owner of a private key 161 that corresponds to the public key 141 included in the obtained DID document 121, thereby verifying that the user is associated with the DID 127 and DID document 121. In various examples, the verifier service 155 can generate a cryptographic challenge and transmit the cryptographic challenge to the client device 109. In various examples, the cryptographic challenge comprises an arbitrary sequence of alphanumeric characters, one or more random phrases, or other type of random string of alphanumeric characters or phrases. In some examples, the cryptographic challenge may comprise a question requesting and answer by the recipient of the cryptographic challenge. In this example, the client device 109 receiving the cryptographic challenge may answer the challenge by signing the challenge or otherwise encrypting the challenge using the private key 161 of the cryptographic key-pair generated by the wallet application 136 and stored in the wallet 139 in association with the DID 127. The cryptographic challenge is generated as an authentication technique to allow the verifier service 155 to verify the user and/or user account associated with the DID 127.

Upon receiving the signed cryptographic challenge from the client device 109, the verifier service 155 can validate the digital signature of the challenge based on the public key 141 included in the DID document 121 and extracted from the DID document. For example, the public key 141 can be used to decrypt the digital signature. Accordingly, the verifier service 155 can verify that the user is associated with the DID 127 and DID document 121 based at least in part on the public key 141 and signed challenge.

In various examples, the verifier service 155 can access a verifier kit 149 from the first computing environment 103 to verify a user verification proof that is a result of the prover kit 146 executed on the client device 109. The verifier kit 149 is generated by the credential service 118 of the first computing environment 103 and can be publicly stored in the first data store 152 for access by the verifier service 155 of the second computing environment 106. According to various examples, the verifier service 155 can verify the user verification proof provided by a client device 109 (e.g., the result of the prover kit 146) in order to prove or otherwise validate the identity of the user initiating the funds transfer and/or the account balance of a financial account of the user initiating the funds transfer. In various examples, the verifier kit 149 works in conjunction with the prover kit 146 to verify a user name, a user address, a user account, an account balance, and/or other types of information.

Also, various data is stored in a second data store 164 that is accessible to the second computing environment 106. The second data store 164 can be representative of a plurality of second data stores 164, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the second data store 164 is associated with the operation of the various applications or functional entities described below. This data can include the verifier kit 149 and potentially other data.

It should be noted that although the first computing environment 103 is shown in FIG. 1 as being a separate environment from the second computing environment 106, in various examples, the functionality described with respect to the first computing environment 103 can also be applied within the second computing environment 106 and the functionality described with respect to the second computing environment 106 can be applied within the first computing environment 103.

The distributed identity ledger 112 represents synchronized, eventually consistent, data stores spread across multiple nodes in different geographic or network locations. Each node in the distributed identity ledger 112 can contain a replicated copy of the distributed identity ledger 112, including all data stored in the distributed identity ledger 112. Records of transactions involving the distributed identity ledger 112 can be shared or replicated using a peer-to-peer network connecting the individual nodes that form the distributed identity ledger 112. Once a transaction or record is recorded in the distributed identity ledger 112, it can be replicated across the peer-to-peer network until the record is eventually recorded with all nodes. Various consensus methods can be used to ensure that data is written reliably to the distributed identity ledger 112. In some implementations, data, once written to the distributed identity ledger 112, is immutable. Examples of a distributed data store that can be used for the distributed identity ledger 112 can include various types of blockchains, distributed hash tables (DHTs), and similar data structures. Various data can be stored in the distributed identity ledger 112. For example, the distributed identity ledger 112 can include DID documents 121 and a revocation list 158.

The client device 109 is representative of a plurality of client devices that can be coupled to the network 115. The client device 109 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 109 can include one or more displays 167, such as liquid crystal displays (LCDs), gas plasma-based flat panel displays, organic light emitting diode (OLED) displays, electrophoretic ink (“E-ink”) displays, projectors, or other types of display devices. In some instances, the display 167 can be a component of the client device 109 or can be connected to the client device 109 through a wired or wireless connection.

The client device 109 can be configured to execute various applications such as a client application 130, a wallet application 136, or other applications. The client application 130 can be executed in a client device 109 to access network content served up by the first computing environment 103, the second computing environment 106, or other servers, thereby rendering a user interface 133 on the display 167. To this end, the client application 130 can include a browser, a dedicated application, or other executable, and the user interface 133 can include a network page, an application screen, or other user mechanism for obtaining user input.

The wallet application 136 can be executed to communicate with the first computing environment 103, the second computing environment 106, and other systems in response to initiation of an identity verification process. In various examples, the wallet application 136 can be executed to generate DID data 170 comprising decentralized identifiers (DIDS) 127 and corresponding key-pairs comprising a public key 141 and a private key 161. In various examples, the wallet application 136 can be executed to communicate with the credential service 118 to provide the generated DID 127 and corresponding public key 141 that are included in the DID document 121 corresponding to a given balance claim 124. Similarly, the wallet application 127 can be executed to communicate with the verifier service 155 to provide the generated DID 127 to the verifier service 155, thereby allowing the verifier service 115 access to the corresponding DID document stored on the distributed identity ledger 112. In addition, in various examples, the wallet application 127 can be executed to execute the prover kit 146 in generating the user information proof that can be verified by the verifier kit 149 to verify user account information.

The wallet application 136 can store and access the DID data 170 from a corresponding wallet 139. In various examples, the wallet 139 corresponds to a digital identity wallet for securely storing the DID data 170, and primarily for storing the private keys 161 associated with one or more DIDs 127 created for the given user. The wallet 139 can comprise a hard wallet or a soft wallet. Although the wallet 139 is illustrated in FIG. 1 as being part of the client device 109, it is understood that the wallet 139 can comprise a separate storage device that can be attached to or otherwise communicatively coupled to the client device 109. In various examples, access to the wallet 139 can require a passcode that is provided by a user to the wallet application 136 to access the wallet 139. For example, the wallet application 136 generates and renders a pop-up box or other type of user interface component requesting the user enter a particular passcode. The passcode can comprise a numeric sequence of numbers (e.g., four to six digits) that is provided by the user. Upon receiving a matching access code, the wallet application 136 can access the DID data 170 stored on the wallet 139.

The DID data 170 included in the wallet 139 and generated by the wallet application 136 comprises a DID 127 and corresponding key-pair comprising a public key 141 and a private key 161. A DID 127 represent an identifier of an individual or entity and can be stored in the identity ledger 112. A DID 127 can represent any self-sovereign identifier used by an individual to assert his or her identity to others and may be stored in the identity ledger 112 to allow others to verify the individual's identity. Accordingly, in some implementations, the DID 127 can include a public key of a public-private key pair controlled by the individual. A DID 127 can be implemented using a variety of approaches, such as the World Wide Web Consortium's (W3C's) Decentralized Identifier (DID) standard.

The public key 141 and the private key 161 correspond to a public-private key pair controlled by the individual and generated by the wallet application 136 in association with a given DID 127. The key-pair can be generated using various approaches, such as elliptic curve cryptography (ECC) approaches or using the Rivest-Shamir-Adleman (RSA) algorithm. In various examples, the public key 141 is transmitted to the credential service 118 with the DID 127 in regard to the creation of the balance claim 124 and DID document 121 corresponding to the DID 127. The private key 161 remains stored in the wallet 136 and can be used to sign any cryptographic challenges sent to the wallet application 136 for user verification.

The client device 109 can be configured to execute applications beyond the client application 130 and the wallet application 136, such as email applications, social networking applications, word processors, spreadsheets, or other applications.

The client data store 173 represents mass storage or memory in which the client device 109 can store information. The client data store 173 can include the prover kit 146 and other data. The prover kit 146 is generated by the credential service 118 and transmitted to the client device 109 upon registration of the balance credential (e.g., DID document 121 and balance claim 124) for the user associated with the corresponding DID 127. The prover kit 146 can represent a script, application, or process that can be executed by the wallet application 136 or client application 130 generate a zero-knowledge proof for verifying user information such as user name, user address, account balance, and/or other type of user information that may need to be verified. The zero-knowledge proof generated by the prover kit 146 can be transmitted to the verifier service 155 in the second computing environment 106. The verifier service 155 can execute a corresponding verifier kit 155 to use the zero-knowledge proof to prove or otherwise validate the identity of the user initiating the funds transfer and/or the account balance of a financial account of the user initiating the funds transfer.

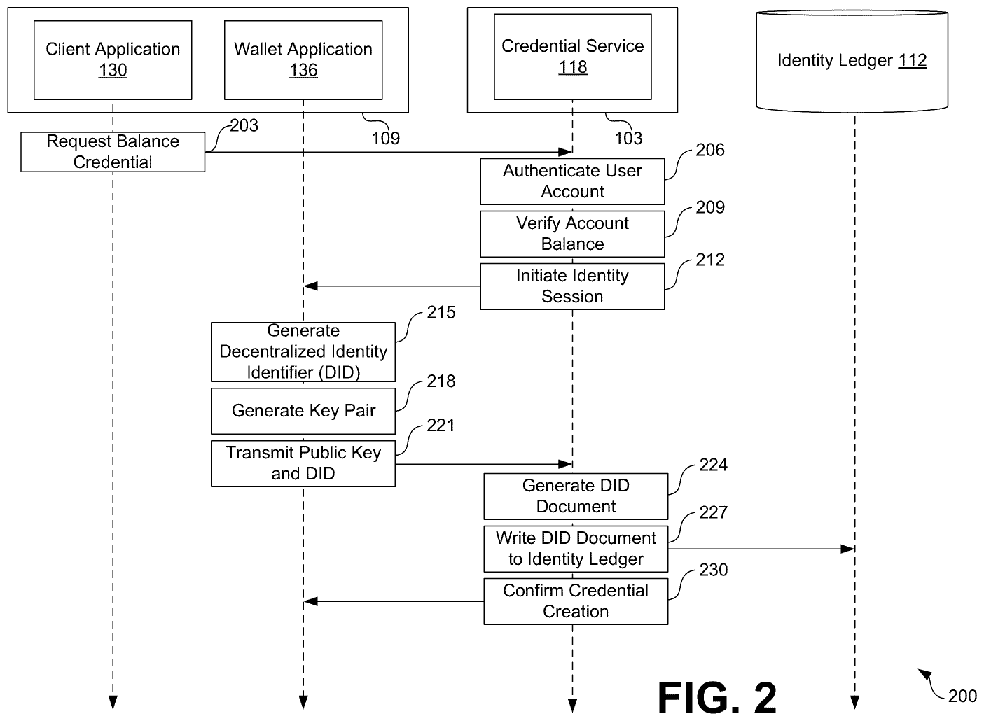

Next, a general description of the operation of the various components of the network environment 100 is provided with reference to FIGS. 2-4. To begin, FIG. 2 illustrates a sequence diagram 200 that provides an example of the operation of the components of the network environment 100. It is understood that the sequence diagram 200 of FIG. 2 provides merely an example of the many different types of functional arrangements that can be employed to implement the operation of the depicted portion of the network environment 100. As an alternative, the sequence diagram 200 of FIG. 2 can be viewed as depicting an example of elements of a method implemented within the network environment 100. In particular, the sequence diagram 200 of FIG. 2 depicts the functionality associated with the creation and registration of a balance credential to the identity ledger 112 in accordance to various embodiments.

Beginning with block 203, a client application 130 executing on the client device 109 can interact with a user interface 133 served up by the credential service 118 and request the creation of a balance credential. For example, the credential service 118 can invite a user interacting with a user interface 133 associated with the first computing environment 103 to register with a balance credential program provided by the credential service 118 that allows the credential service 118 to generate the balance claim 124 according to an account balance for one or more financial accounts of the user that are provided by a financial entity of the first computing environment 103. Accordingly, the client application 130 can send a request for the creation of the balance credential upon accepting the invitation to register with the balance credential program.

At block 206, the credential service 118 authenticates the user account requesting the creation of the balance credential. For example, the credential service 118 can request authenticating credentials (e.g., user name, password) from the user interacting with the client application 130 that are required to authenticate the user and corresponding user account for creation of the balance credential. Once the credential service 118 receives the authentication credentials, the credential service 118 can compare the authentication credentials with the user account data 143 to verify a match and authenticate the user account.

At block 209, the credential service 118 verifies the account balance for the authenticated user account. For example, the credential service 118 can access the user account data 143 for the user account to determine the current account balance. To verify the account balance, the credential service 118 can determine that the account balance meets or exceeds a predefined balance threshold. In some examples, the minimum balance threshold is defined by an agreement between the user and the entity associated with the credential service 118. In other examples, the minimum balance threshold is defined by credential service 118. If the current account balance fails to meet or exceed the minimum balance threshold, the credential service 118 will be unable to issue a balance credential for the user account and therefore, this portion of the process would proceed to completion. Otherwise, the process proceeds to block 209.

At block 212, the credential service 118 initiates the identity verification session with the wallet application 136 on the client device 109. In various examples, the credential service 118 can detect a wallet application 136 and/or corresponding wallet 139 associated with the client device 109 in response to interactions with the client device 109. In some examples, the credential service 118 generates a selectable link that can be rendered on a user interface of the client device 109. Upon selection of the link by the user interacting with the user interface 133, the credential service 118 can initiate the identity verification session between the wallet application 136 and the credential service 118. In other examples, the credential service 118 can generate and render a quick response (QR) code or other type of authentication code on a display and the client device 109 can scan the QR code to initiate the identity verification session between the credential service 118 and the wallet application 136.

At block 215, the wallet application 136 generates the DID 127. A DID 127 represent an identifier of an individual or entity and can be stored in the identity ledger 112. A DID 127 can represent any self-sovereign identifier used by an individual to assert his or her identity to others and may be stored in the identity ledger 112 to allow others to verify the individual's identity. A DID 127 can be implemented using a variety of approaches, such as the World Wide Web Consortium's (W3C's) Decentralized Identifier (DID) standard.

At block 218, the wallet application 136 generates the public key 141 and the private key 161 corresponding to a public-private key pair in association with a given DID 127. The key-pair can be generated using various approaches, such as elliptic curve cryptography (ECC) approaches or using the Rivest-Shamir-Adleman (RSA) algorithm. As can be appreciated, the public-private key pair is controlled by the individual associated with the DID 127. Accordingly, the private key 161 can be securely stored in the wallet 139 and accessed by the individual. In various examples, access to the wallet 139 can require a passcode that is provided by the user. For example, the wallet application 136 generates and renders a pop-up box or other type of user interface component requesting the user enter a particular passcode.

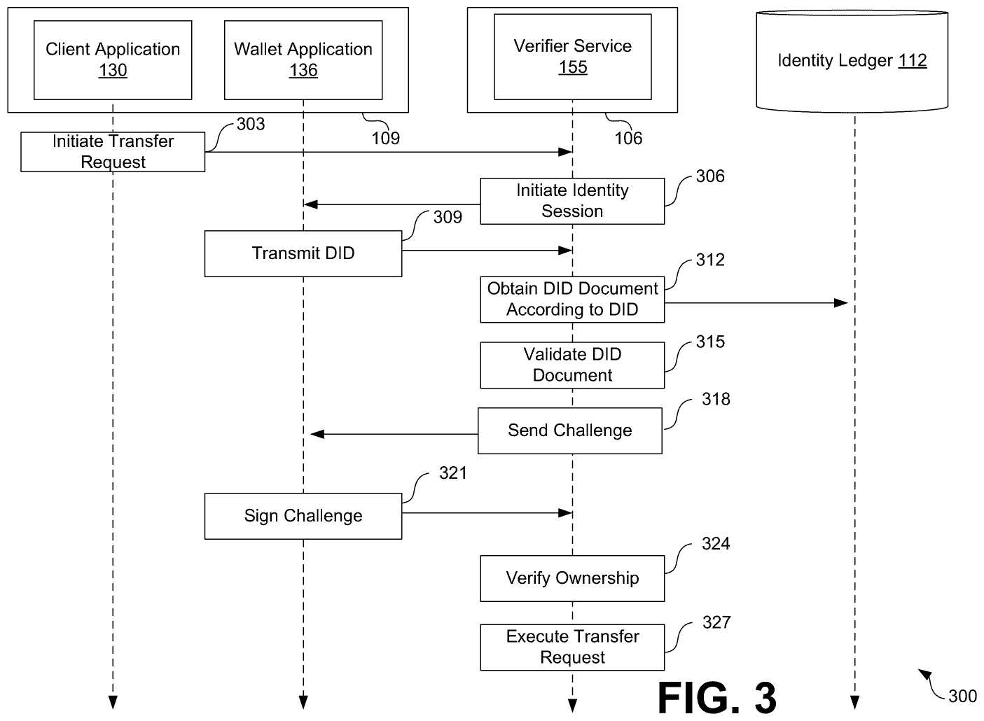

At block 221, the wallet application 136 transmits the DID 127 and the public key 141 to the credential service 118. The DID 127 is provided to associate the credential (e.g., DID document 121 and balance claim 124) to the given individual as well as to indicate how to store and access the credential on the identity ledger 112 in association with the given individual. The public key 141 is provided to the wallet application 136 for inclusion in the DID document 121. As such, inclusion of the public key 141 in the DID document 121 can facilitate further verification of the DID document 121 and ownership of the individual during the verification process performed by the verifier service 155 as will be discussed with regard to FIG. 3.

At block 224, the credential service 118 generates the DID document 121. In particular, a DID document 121 comprises a document that can be written to and accessed from a distributed identity ledger 112. The DID document 121 is generated to include information related to a user identified by a specific DID 127. For example, the DID document 121 is generated to include a balance claim 124 claiming that the account balance for a user account associated with a DID 127 of the user satisfies a minimum balance threshold. In addition, the DID document 121 can include the DID 127, the public key 141, and other information specific to the individual. Further, the DID document 121 can be digitally signed by the entity associated with the credential service 118. As such, verifiers verifying the DID document 121 can determine who created the DID document 121 and determine whether the DID document 121 was created by a trusted entity based at least in part on the digital signature. In various examples, the DID document 121 is implemented using various standards, such as the World Wide Web Consortium's (W3C's) Decentralized Identifier (DID) standard.

At block 227, the credential service 118 saves the DID document 121 to the identity ledger 112. For example, the credential service 118 could write the DID document 121 to the identity ledger 112 or provide the DID document 121 to the identity ledger 112 for distribution across the nodes of the identity ledger 112. As a result, the individual associated with the DID 127, DID document 121 and balance claim 124 is recognized as being the owner of a financial account having a balance that at least satisfies the minimum balance threshold.

At block 230, the credential service 118 confirms with the wallet application 136 that the DID document 121 comprising the balance claim 124 has been saved to the identity ledger 112. In some examples, the credential service 118 can provide the balance claim 124 in the form of a verifiable credential to the wallet application 136. In other examples, the DID 127 can be used as the verifiable credential for the given user. Thereafter, this portion of the process proceeds to completion.

Turning now to FIG. 3, shown is a sequence diagram 300 that provides an example of the operation of the components of the network environment 100. It is understood that the sequence diagram 300 of FIG. 3 provides merely an example of the many different types of functional arrangements that can be employed to implement the operation of the depicted portion of the network environment 100. As an alternative, the sequence diagram 300 of FIG. 3 can be viewed as depicting an example of elements of a method implemented within the network environment 100. In particular, the sequence diagram 300 of FIG. 3 depicts the functionality associated with the verification of a balance credential associated with a DID 127 in response to a funds transfer request in accordance to various embodiments of the present disclosure.

Beginning with block 303, a client application 130 executing on a client device 109 sends a transfer request to a second computing environment 106 requesting initiating of a transfer of funds between one or more financial institutions. For example, the second computing environment 106 can correspond to a financial institution (e.g., bank, credit unions, brokerage firms, mortgage companies, etc.) or other entity that can be used initiate a transfer of funds between one or more financial intuitions and verify the financial account data associated with a user requesting the transfer of funds. For example, the financial institution may initiate an ACH payment process, a loan advance process, a wire transfer and/or other type of funds transfer.

At block 306, the verifier service 155 initiates an identity verification process with the wallet application 136 on the client device 109. In various examples, the verifier service 155 can detect a wallet application 136 and/or corresponding wallet 139 associated with the client device 109 in response to interactions with the client device 109. In some examples, the verifier service 155 generates a selectable link that can be rendered on a user interface of the client device 109. Upon selection of the link by the user interacting with the user interface 133, the verifier service 155 can initiate the identity verification session between the wallet application 136 and the verifier service 155. In other examples, the verifier service 155 can generate and render a quick response (QR) code or other type of authentication code on a display and the client device 109 can scan the QR code to initiate the identity verification session between the verifier service 155 and the wallet application 136.

At block 309, the wallet application 136 transmits the DID 127 associated with the specific individual to the verifier service 155. In various examples, the DID 127 represents an identifier of an individual or entity and can be stored in the identity ledger 112 in association with the balance claim 124 claiming that the financial account of an individual associated with the DID 127 satisfies the minimum balance threshold condition. The wallet application 136 provides the DID 127 to the verifier service 155 to allow the verifier service 155 access to the DID document 121 saved on the identity ledger 115.

At block 312, the verifier service 115 obtains the DID document 121 corresponding to the DID 127 from the identity ledger 112. The DID document 121 is generated to include information related to a user identified by a specific DID 127 and is stored in the identity ledger 112 in association with the specific DID 127. In various examples, the DID document 121 includes a balance claim 124 claiming that the account balance for a user account associated with the DID 127 of the user satisfies a minimum balance threshold. In addition, the DID document 121 includes DID 127, the public key 141, and other information specific to the individual. In some examples, the DID document 121 can be digitally signed by the entity associated with the credential service 118.

At block 315, the verifier service 115 validates the DID document 121. In various examples, the verifier service 115 can validate the DID document 121 by determining that the DID document 121 was created and signed by a trusted entity (e.g., the first computing environment 103 or credential service 118). In addition, the verifier service 155 can determine whether the balance claim 124 indicates that the account balance of the corresponding financial account meets or exceeds the minimum threshold amount. In addition, the verifier service 155 can determine whether balance claim 124 has been revoked or if it is still active. For example, if the balance claim 124 is revoked (e.g., the account balance no longer meets or exceeds the minimum balance threshold), reference to the balance claim 124 or DID 127 may be included in a revocation list 158 stored in the identified ledger 112.

At block 318, the verifier service 155 generates and sends a cryptographic challenge to the wallet application 136. In various examples, the cryptographic challenge comprises an arbitrary sequence of alphanumeric characters, one or more random phrases, or other type of random string of alphanumeric characters or phrases. In some examples, the cryptographic challenge may comprise a question requesting and answer by the recipient of the cryptographic challenge. The cryptographic challenge is generated as an authentication technique to allow the verifier service 155 to verify the user and/or user account associated with the DID 127.

At block 321, the wallet application 136 signs the cryptographic challenge and returns the signed cryptographic challenge to the verifier service 155. In this example, the wallet application may answer the challenge by signing the challenge or otherwise encrypting the challenge using the private key 161 of the cryptographic key-pair generated by the wallet application 136 and stored in the wallet 139 in association with the DID 127.

At block 324, the verifier service 155 verifies that the requesting user is the owner of a private key 161 that corresponds to the public key 141 included in the obtained DID document 121, thereby verifying that the user is associated with the DID 127 and DID document 121. For example, the verifier service 155 can extract the public key 141 included in the obtained DID document 121. Upon extracting the public key 141 and receiving the signed cryptographic challenge, the verifier service 155 can verify that the private key 161 used to sign the cryptographic challenge corresponds to the public key 141 included in the DID document 121.

At block 327, the verifier service 155 executes the transfer request. For example, if the transfer requests corresponds to the transfer of funds from the first computing environment 103 to the second computing environment 106 in the form of an ACH request, the verifier service 155 can authorize and execute the transfer request by requesting the transfer of funds from the first computing environment 103 to the second computing environment 106. Thereafter, this portion of the process proceeds to completion.

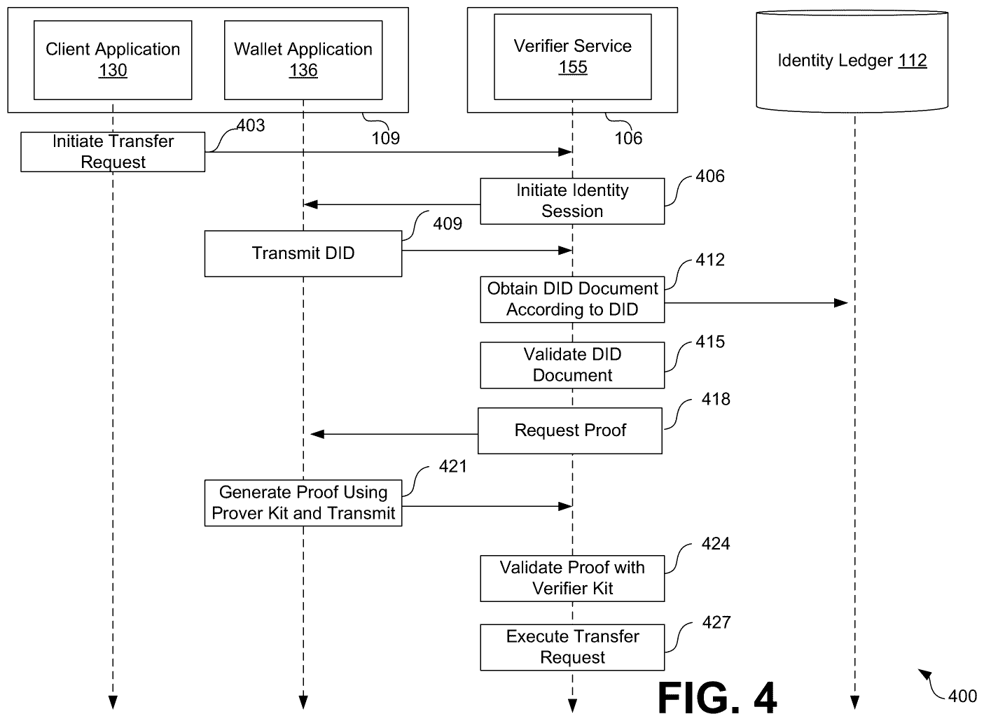

Moving on to FIG. 4, shown is a sequence diagram 400 that provides an example of the operation of the components of the network environment 100. It is understood that the sequence diagram 400 of FIG. 4 provides merely an example of the many different types of functional arrangements that can be employed to implement the operation of the depicted portion of the network environment 100. As an alternative, the sequence diagram 400 of FIG. 4 can be viewed as depicting an example of elements of a method implemented within the network environment 100. In particular, the sequence diagram 400 of FIG. 4 depicts the functionality associated with the verification of a balance credential associated with a DID 127 in response to a funds transfer request and the use of zero-knowledge proofs for additional user verification in accordance to various embodiments of the present disclosure.

Beginning with block 403, a client application 130 executing on a client device 109 sends a transfer request to a second computing environment 106 requesting initiating of a transfer of funds between one or more financial institutions. For example, the second computing environment 106 can correspond to a financial institution (e.g., bank, credit unions, brokerage firms, mortgage companies, etc.) or other entity that can be used initiate a transfer of funds between one or more financial intuitions and verify the financial account data associated with a user requesting the transfer of funds. For example, the financial institution may initiate an ACH payment process, a loan advance process, a wire transfer and/or other type of funds transfer.

At block 406, the verifier service 155 initiates an identity verification process with the wallet application 136 on the client device 109. In various examples, the verifier service 155 can detect a wallet application 136 and/or corresponding wallet 139 associated with the client device 109 in response to interactions with the client device 109. In some examples, the verifier service 155 generates a selectable link that can be rendered on a user interface of the client device 109. Upon selection of the link by the user interacting with the user interface 133, the verifier service 155 can initiate the identity verification session between the wallet application 136 and the verifier service 155. In other examples, the verifier service 155 can generate and render a quick response (QR) code or other type of authentication code on a display and the client device 109 can scan the QR code to initiate the identity verification session between the verifier service 155 and the wallet application 136.

At block 409, the wallet application 136 transmits the DID 127 associated with the specific individual to the verifier service 155. In various examples, the DID 127 represents an identifier of an individual or entity and can be stored in the identity ledger 112 in association with the balance claim 124 claiming that the financial account of an individual associated with the DID 127 satisfies the minimum balance threshold condition. The wallet application 136 provides the DID 127 to the verifier service 155 to allow the verifier service 155 access to the DID document 121 saved on the identity ledger 115.

At block 412, the verifier service 115 obtains the DID document 121 corresponding to the DID 127 from the identity ledger 112. The DID document 121 is generated to include information related to a user identified by a specific DID 127 and is stored in the identity ledger 112 in association with the specific DID 127. In various examples, the DID document 121 includes a balance claim 124 claiming that the account balance for a user account associated with the DID 127 of the user satisfies a minimum balance threshold. In addition, the DID document 121 includes DID 127, the public key 141, and other information specific to the individual. In some examples, the DID document 121 can be digitally signed by the entity associated with the credential service 118.

At block 415, the verifier service 115 validates the DID document 121. In various examples, the verifier service 115 can validate the DID document 121 by determining that the DID document 121 was created and signed by a trusted entity (e.g., the first computing environment 103 or credential service 118). In addition, the verifier service 155 can determine whether the balance claim 124 indicates that the account balance of the corresponding financial account meets or exceeds the minimum threshold amount. In addition, the verifier service 155 can determine whether balance claim 124 has been revoked or if it is still active. For example, if the balance claim 124 is revoked (e.g., the account balance no longer meets or exceeds the minimum balance threshold), reference to the balance claim 124 or DID 127 may be included in a revocation list 158 stored in the identified ledger 112.

At block 418, the verifier service 155 requests a proof from the wallet application 136. In various examples, the proof can comprise a user verification proof and can be used to verify user information associated with the user associated with the DID 127. For example, the proof can be used to verify a user name, a user address, a user account, an account balance, and/or other types of information. In some examples, the requested proof can be used to verify that an account balance associated with the user is within a given threshold. For example, while the balance claim 124 associated with the DID 127 may indicate that the account balance meets or exceed a predefined minimum balance threshold, the second computing environment 106 may want to verify that the account balance meets or exceeds a balance that differs from the predefined minimum balance threshold. In various examples, the proof is the result of a prover kit 146 executed on the client device 109 and can be used in conjunction with a verifier kit 149 to verify the desired user verification information.

At block 421, the wallet application 136 generates the proof using the prover kit 146 and transmits the proof to the verifier service 155. The prover kit 146 can represent a script, application, or process that can be executed by the wallet application 136 to generate the zero-knowledge proof for verifying user information such as user name, user address, account balance, and/or other type of user information that may need to be verified. The prover kit 146 is generated by the credential service 118 and transmitted to the client device 109 upon registration of the balance credential (e.g., DID document 121 and balance claim 124) for the user associated with the corresponding DID 127. Upon generating the proof, the wallet application 136 transmits the proof to the verifier service 155.

At block 424, the verifier service 155 verifies the user information by validating the received proof using the corresponding verifier kit 149. In various examples, the verifier service 155 can access a verifier kit 149 from the first computing environment 103 to verify the proof that is a result of the prover kit 146 executed on the client device 109. The verifier kit 149 is generated by the credential service 118 of the first computing environment 103 and can be publicly stored in the first data store 152 for access by the verifier service 155 of the second computing environment 106. According to various examples, the verifier service 155 can verify the proof provided by a client device 109 (e.g., the result of the prover kit 146) in order to prove or otherwise validate the identity of the user initiating the funds transfer and/or the account balance of a financial account of the user initiating the funds transfer. In various examples, the verifier kit 149 works in conjunction with the prover kit 146 to verify a user name, a user address, a user account, an account balance, and/or other types of information.

At block 427, the verifier service 155 executes the transfer request. For example, if the transfer requests corresponds to the transfer of funds from the first computing environment 103 to the second computing environment 106 in the form of an ACH request, the verifier service 155 can authorize and execute the transfer request by requesting the transfer of funds from the first computing environment 103 to the second computing environment 106. Thereafter, this portion of the process proceeds to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies.

These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103,106.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a transfer request from a user device;
validate a balance credential on a distributed ledger based at least in part on a decentralized identity identifier (DID) received from the user device, the balance credential claiming that a user account balance associated with a user account of a user associated with the user device satisfies a minimum balance;
verify an ownership of the balance credential by a user based at least in part on a cryptographic challenge or a zero-knowledge proof algorithm; and
execute the transfer request in response to validating the balance credential on the distributed ledger and verifying the ownership of balance credential.

2. The system of claim 1, wherein the balance credential is verified based at least in part on a DID document stored on the distributed ledger, the DID document comprising a public key of a cryptographic key pair generated by a wallet of the user device.

3. The system of claim 2, wherein validating the balance credential further comprises determining that the balance credential is issued by a trusted entity based at least in part on a signature associated with the DID document.

4. The system of claim 2, wherein the computing device comprises a first computing device, and the machine-readable instructions further cause the first computing device to at least extract the public key from the DID document.

5. The system of claim 4, wherein the machine-readable instructions further cause the computing device to at least:
generate the cryptographic challenge;
transmit the cryptographic challenge to the user device; and
receive a signed cryptographic challenge from the user device, the ownership being verified in response to determining that the cryptographic challenge is signed with a private key associated with the public key.

6. The system of claim 1, wherein the ownership is verified based at least in part on the zero-knowledge proof algorithm, and the machine-readable instructions further cause the computing device to at least receive a user verification proof from the user device.

7. The system of claim 6, wherein the user verification proof is generated by a prover kit executed by the user device, and verifying the ownership further comprises verifying the user verification proof by executing a verifier kit, the prover kit and the verifier kit being based at least in part on the zero-knowledge proof algorithm.

8. A method, comprising:
receiving a transfer request from a user device;
validating a balance credential on a distributed ledger based at least in part on a decentralized identity identifier (DID) received from the user device, the balance credential claiming that a user account balance associated with a user account of a user associated with the user device satisfies a minimum balance;
verifying an ownership of the balance credential by a user based at least in part on a cryptographic challenge or a zero-knowledge proof algorithm; and
executing the transfer request in response to validating the balance credential on the distributed ledger and verifying the ownership of balance credential.

9. The method of claim 8, wherein the balance credential is verified based at least in part on a DID document stored on the distributed ledger, the DID document comprising a public key of a cryptographic key pair generated by a wallet of the user device.

10. The method of claim 9, wherein validating the balance credential further comprises determining that the balance credential is issued by a trusted entity based at least in part on a signature associated with the DID document.

11. The method of claim 9, further comprising extracting the public key from the DID document.

12. The method of claim 11, further comprising:
generating the cryptographic challenge;
transmitting the cryptographic challenge to the user device; and
receiving a signed cryptographic challenge from the user device, the ownership being verified in response to determining that the cryptographic challenge is signed with a private key associated with the public key.

13. The method of claim 8, wherein the ownership is verified based at least in part on the zero-knowledge proof algorithm, and further comprising receiving a user verification proof from the user device.

14. The method of claim 13, wherein the user verification proof is generated by a prover kit executed by the user device, and verifying the ownership further comprises verifying the user verification proof by executing a verifier kit, the prover kit and the verifier kit being based at least in part on the zero-knowledge proof algorithm.

15. A non-transitory, computer-readable medium, comprising machine-readable instructions that, when executed by a processor of a computing device, cause the computing device to at least:
receive a transfer request from a user device;
validate a balance credential on a distributed ledger based at least in part on a decentralized identity identifier (DID) received from the user device, the balance credential claiming that a user account balance associated with a user account of a user associated with the user device satisfies a minimum balance;
verify an ownership of the balance credential by a user based at least in part on a cryptographic challenge or a zero-knowledge proof algorithm; and
execute the transfer request in response to validating the balance credential on the distributed ledger and verifying the ownership of balance credential.

16. The non-transitory, computer-readable medium of claim 15, wherein the balance credential is verified based at least in part on a DID document stored on the distributed ledger, the DID document comprising a public key of a cryptographic key pair generated by a wallet of the user device.

17. The non-transitory, computer-readable medium of claim 16, wherein validating the balance credential further comprises determining that the balance credential is issued by a trusted entity based at least in part on a signature associated with the DID document.

18. The non-transitory, computer-readable medium of claim 16, wherein the machine-readable instructions, when executed by the processor, further cause the computing device to at least extract the public key from the DID document.

19. The non-transitory, computer-readable medium of claim 18, wherein the machine-readable instructions, when executed by the processor, further cause the computing device to at least:
generate the cryptographic challenge;
transmit the cryptographic challenge to the user device; and
receive a signed cryptographic challenge from the user device, the ownership being verified in response to determining that the cryptographic challenge is signed with a private key associated with the public key.

20. The non-transitory, computer-readable medium of claim 15, wherein the ownership is verified based at least in part on the zero-knowledge proof algorithm, and the machine-readable instructions, when executed by the processor, further cause the computing device to at least receive a user verification proof from the user device, the user verification proof being generated by a prover kit executed by the user device, and verifying the ownership further comprises verifying the user verification proof by executing a verifier kit, the prover kit and the verifier kit being based at least in part on the zero-knowledge proof algorithm.
